(19) United States
(12) Patent Application Publication
(10) Pub. No.: US 2026/0329958 A1
(43) Pub. Date: Oct. 22, 2026

(54) INTENT-BASED DELIVERY OF MACHINE-OPTIMIZED WEB CONTENT FOR ARTIFICIAL INTELLIGENCE REQUESTORS

(71) Applicant: Dorian Cartwright, San Jose, CA (US)

(72) Inventor: Dorian Cartwright, San Jose, CA (US)

(21) Appl. No.: 19/569,646

(22) Filed: Mar. 17, 2026

Related U.S. Application Data
(60) Provisional application No. 63/954,067, filed on Jan. 5, 2026.

(51) Int. Cl. G06F 16/954

(52) U.S. Cl. CPC G06F 16/954

(57) ABSTRACT

A server system receives a request for a web resource, analyzes request characteristics to determine that the request originates from an artificial intelligence requestor, classifies the requestor into an artificial intelligence sub-intent, selects a machine-oriented representation of the web resource based on the classified sub-intent, and transmits the selected machine-oriented representation in place of a default presentation-layer representation. The sub-intent may comprise training ingestion, real-time inferencing, retrieval refresh, entity extraction, media understanding, quality or compliance evaluation, or functional execution by an artificial intelligence agent browser. Different machine-oriented representations may include token-reduced semantic representations, compact fact-chunk representations, schema-structured representations, transcript-based semantic representations, metadata-only representations, or actionable form-schema or API-like representations. In various embodiments, the selected machine-oriented representation reduces token count, markup complexity, bandwidth consumption, latency, or multimodal processing burden relative to the default presentation-layer representation.

### CROSS-REFERENCE TO RELATED APPLICATIONS

The present application claims priority under 35 USC 119(e) to U.S. 63/954,067 filed on Jan. 5, 2026, titled DUAL-PATH WEB CONTENT DELIVERY OPTIMIZED FOR GENERATIVE AI RETRIEVAL AND HUMAN INTERACTION by Dorian Cartwright, the contents of which are hereby incorporated in its entirety.

### FIELD OF THE INVENTION

The present invention relates generally to computer systems and web pages and, more specifically, to intent-based delivery of machine-optimized web content for artificial intelligence requestors.

### BACKGROUND

Traditional web publishing infrastructure has been optimized primarily for human consumption and for conventional search-engine indexing. In such systems, web pages are commonly authored to maximize visual engagement, navigation depth, session duration, and search ranking signals. Hypertext Markup Language (HTML), cascading style sheets, scripts, media layers, and user-interface elements are assembled to produce a narrative-rich and interactive presentation for human users, while search-engine index crawlers generally retrieve substantially the same presentation-oriented content for indexing.

The emergence of large language models, retrieval-augmented generation systems, multimodal inference systems, autonomous browsing agents, and other machine-driven web consumers has introduced materially different technical requirements. These systems do not necessarily consume a page to experience its rendered layout. Instead, they may extract facts, construct embeddings, refresh a retrieval corpus, populate a knowledge graph, evaluate provenance, complete a workflow, or derive machine-actionable state transitions. Presentation markup, decorative interface elements, long narrative transitions, and visually oriented structures that are useful to human users can create processing overhead, token waste, or retrieval noise for machine-driven systems.

Existing systems often rely on a single document object model and a single outward-facing representation for all requestors, thereby forcing a compromise between human readability, search-engine indexing, and machine-oriented extractability. Even when a site publishes structured metadata, such metadata often reflects only a narrow subset of page content and typically does not vary according to the downstream computational objective of the requestor. As a result, conventional delivery architectures do not adequately distinguish among different artificial intelligence processes, such as training ingestion, real-time inferencing, retrieval refresh, entity extraction, media understanding, compliance evaluation, or autonomous agent execution.

Existing approaches such as llms.txt provide only a static, publisher-authored manifest of selected content and links, and therefore do not dynamically adapt content delivery based on the actual purpose of a requesting AI system. The proposal is informal and intentionally leaves downstream processing unspecified, which limits interoperability and consistent machine behavior across different AI workflows. It also depends on site operators to create and maintain separate manifests and, in many implementations, companion markdown pages, creating synchronization and maintenance burdens as site content changes. In addition, a static llms.txt file may omit interactive, contextual, temporal, or sub-intent-specific aspects of a web resource, making it inadequate for request-time selection of representations tailored to different AI ingestion, retrieval, extraction, or agent-execution tasks.

Accordingly, there is a need for a system that can determine not merely that a requestor is machine-driven, but also the probable machine sub-intent associated with the request. There is a further need for a system that can select among multiple machine-oriented representations of a common underlying web resource so that each request class receives a representation aligned to its technical objective while preserving a separate presentation-layer experience for human-facing browsing and other conventional clients.

### SUMMARY

The present disclosure addresses these shortcomings with methods, systems, and computer program products that analyze characteristics of incoming requests, determine whether a request originates from an artificial intelligence requestor, classify the requestor into one or more artificial intelligence sub-intents, and select a machine-oriented representation of a web resource based on the classified sub-intent. The selected representation is then transmitted in place of a default presentation-layer representation, such as a human-facing browser representation.

In one embodiment, a request analysis module evaluates one or more request characteristics, including header patterns, user-agent fingerprinting, client hints, request cadence, request-path behavior, authentication or session state, cross-domain telemetry, anomaly signals, and policy rules, to determine that a request originates from an artificial intelligence requestor. The request analysis module then resolves an artificial intelligence sub-intent, such as training ingestion, real-time inferencing, retrieval refresh, entity extraction, media understanding, quality or compliance evaluation, or functional execution by an artificial intelligence agent browser. A representation selector maps the classified sub-intent to a corresponding representation identifier and retrieves or generates an associated machine-oriented representation.

In different embodiments, the machine-oriented representation may comprise a token-reduced semantic representation, a compact fact-chunk representation, a schema-structured representation, a transcript-based semantic representation, a metadata-only representation, or an actionable form-schema or API-like representation. By selecting the representation according to sub-intent, the system can reduce token count, markup complexity, bandwidth consumption, latency, or multimodal processing burden relative to a default presentation-layer representation.

In some embodiments, the request analysis module is deployed at a network edge layer, such as a content delivery network, managed web application firewall, or shared cloud hosting layer, enabling aggregation of telemetry across multiple domains and generation of a macro-intent or global reputation profile for a requestor. In further embodiments, the selected machine-oriented representation includes integrity metadata or a verification hash associating the machine-oriented representation with the default presentation-layer representation. Additional embodiments provide confidence-based fallback selection, dual-mode delivery for autonomous agents, and media-specific semantic packages for video, audio, or image-associated assets.

In some embodiments, the machine-oriented representation pipeline is invoked in response to requests from external AI requestors. In other embodiments, the same pipeline is invoked by internally scheduled or event-triggered AI workflows of the host environment. Thus, the representation selector may operate for both externally facing AI delivery and internally facing AI auditing, indexing, governance, or optimization tasks.

### BRIEF DESCRIPTION OF FIGURES

The accompanying drawings, which are incorporated in and constitute a part of this specification, illustrate exemplary embodiments of the present invention and, together with the detailed description, serve to explain the principles, features, and operation of the disclosed subject matter. Like reference numerals generally refer to like elements throughout the drawings.

FIG. 1 is a block diagram of an example networked environment in which a server system receives requests from human-facing browsers, index crawlers, artificial intelligence requestors, and artificial intelligence agent browsers, and selectively serves a default presentation-layer representation or one of multiple machine-oriented representations, according to an embodiment.

FIG. 2 is a functional block diagram of an example server system including a request analysis module, a representation selector, a content transformation engine, a telemetry aggregation engine, and a verification module configured to generate and deliver sub-intent-specific representations of web resources, according to an embodiment.

FIG. 3 is a flowchart illustrating an example method in which a request is intercepted, analyzed to determine whether it originates from an artificial intelligence requestor, classified into an artificial intelligence sub-intent, mapped to a selected representation, and served in place of a default presentation-layer representation, according to an embodiment.

FIG. 4 is a block diagram of an example computing device suitable for implementing the web host, edge server, content transformation engine, or other components described herein, according to an embodiment.

### DETAILED DESCRIPTION

The following description provides methods, systems, and computer program products for intent-based delivery of machine-optimized web content for artificial intelligence requestors. The described embodiments are illustrative and are not limiting. A person of ordinary skill in the art will recognize that features described in connection with one embodiment may be combined with features of other embodiments unless otherwise indicated.

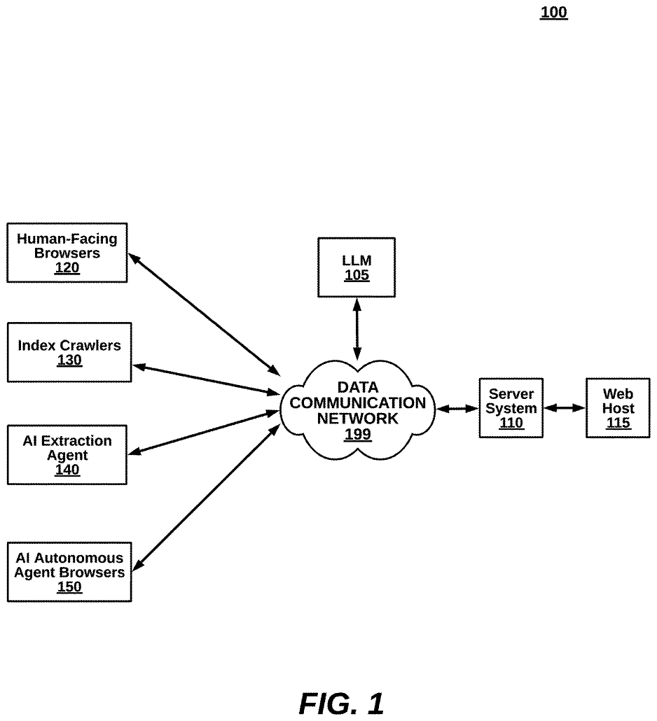

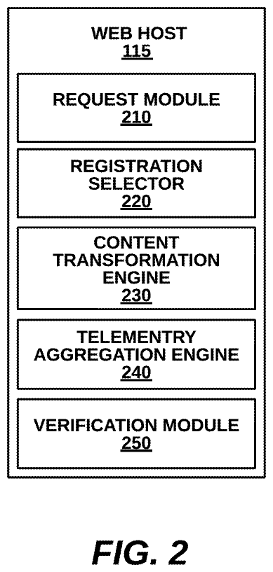

### I. Systems for Intent-Optimized Web Content Delivery for AI Ingestion (FIGS. 1-2)

In an example deployment, a server system 110 hosts or proxies access to one or more web resources and receives requests from a plurality of request classes, including human-facing browsers 120, search engine index crawlers 130, artificial intelligence extraction agents 140 and autonomous agent browsers 150 among others (e.g., retrieval systems and multimodal consumers). The server system 110 may reside at an origin server, reverse proxy, content delivery network edge, web application firewall, or other network layer capable of intercepting and evaluating incoming requests before selecting a response representation. In turn, a web host 115 stores web pages, web applications and other web resources sought by requestors. In one embodiment, the server system 110 and the web host 115 are integrated into a single device or unifying software platform.

The server system 110 may determine whether to return a stored (pre-processed) or generate (process on-the-fly) multiple representations of a common underlying web resource held on the web host 115. A default presentation-layer representation on the web host 115 may correspond to a human-facing browser representation, such as rendered HTML and associated scripts or assets. A search index crawler 130 representation may be search engine optimization (SEO) optimized. Additional representations may be machine-oriented and may omit, transform, reorder, or augment content in a manner aligned to a downstream machine objective. Rather than treating traffic as merely human or non-human, the server system 110 first determines that the request originates from an AI requestor and then resolves a more specific AI version associated with the requestor. The AI version may correspond to an operational mode, task profile, pipeline role, agent type, or request-class variant of the AI requestor. The system may then determine a sub-intent within the resolved AI version, such that different AI versions of the same requestor may be associated with different sub-intents and different representation-selection outcome.

In some embodiments, the request analyzed by the sever system 110 is not an external network request from a third-party AI system, but is an internally initiated processing request originating from a web host, content platform, publisher, enterprise, or hosting environment itself. The internal request may correspond to auditing, compliance, indexing, summarization, moderation, search, retrieval-refresh, policy-enforcement, cybersecurity, or agent-execution workflow performed by one or more internal AI systems. In response to the internal request, the system selects a machine-oriented representation of a web resource based on an internal AI sub-intent and provides the selected representation to the internal AI system in place of a default presentation-layer representation, thereby reducing internal token consumption, context-window usage, markup parsing burden, or multimodal processing burden.

A downstream large language model (LLM) 105, in some embodiments, is utilized for inferencing, summarization, extraction, retrieval-augmented generation, planning, ranking, citation generation, or other language-model-driven processing, machine-oriented contents pulled by an artificial intelligence requestor 140 and/or an autonomous agent browser 150. In many LLM-based systems, processing cost is correlated with the amount of input and output text represented as tokens, and additional cost, latency, and context-window consumption may result when a conventional presentation-layer web page includes markup, scripts, navigation elements, decorative text, repeated boilerplate, or multimodal content that is not substantively required for the downstream machine task.

As used herein, LLM processing cost refers to resource consumption associated with processing content by a large language model, including token-based usage, inference compute, memory utilization, context-window consumption, bandwidth, latency, energy expenditure, monetary API cost, or any combination thereof. LLM usage may also incur a direct monetary cost, for example where a model provider charges based on input tokens, output tokens, requests, context length, compute tier, or multimodal processing. Accordingly, reducing unnecessary tokens and non-substantive content can reduce not only inference overhead and latency, but also out-of-pocket usage expense. Accordingly, server system 110 may reduce LLM processing cost by selecting a machine-oriented representation that conserves tokens relative to a default presentation-layer representation, for example by removing presentation markup, omitting non-substantive interface content, compacting factual content into semantically coherent chunks, generating schema-structured payloads, supplying metadata-only outputs, or otherwise reducing token count, markup complexity, bandwidth consumption, latency, or multimodal processing burden while preserving information relevant to the classified artificial intelligence sub-intent.

By contrast, non-LLM downstream processes may use other representations of the same underlying web resource according to their respective objectives. A human-facing browser 120 may receive a default presentation-layer representation and render the returned HTML and associated assets for visual display and user interaction on a client device. A search engine index crawler 130 may receive a crawler-oriented representation and process the returned content to create, update, or refine a search index, ranking signal set, or snippet corpus for subsequent retrieval by a search engine. Thus, server system 110 may preserve a presentation-oriented experience for human users and an indexing-oriented representation for crawler systems while separately delivering machine-oriented representations for artificial intelligence requestors whose downstream objective is different from visual browsing or conventional search indexing.

### Request Analysis Module

While a conventional system merely returns stored web resources, request analysis module 112 intercepts or otherwise receives request data and analyzes one or more request characteristics to determine whether the request originates from an artificial intelligence requestor. The request characteristics may include one or more of header analysis, client-hint analysis, user-agent fingerprinting, content-negotiation headers, request path patterns, authentication or session state, request cadence, anomaly scoring, policy rules, or machine-learned classification outputs. In some embodiments, the request analysis module 112 compares request signatures against a maintained catalog (e.g., collected or a third-party database) of known crawlers, agent frameworks, headless browsers, or API clients. In other embodiments, the request analysis module 112 determines likely machine origin through behavioral indicators even when a requestor attempts to mimic a conventional browser.

Once machine origin is detected, the request analysis module 112 classifies the artificial intelligence requestor into one of a plurality of artificial intelligence sub-intents. The classification may be a single label, a weighted combination of labels, or a confidence-scored intent profile. A representation selector then maps the classified sub-intent to one of a plurality of machine-oriented representations of the requested web resource. Where confidence is low, the selector may choose a fallback representation or may blend multiple representations, such as a compact fact-chunk payload combined with provenance metadata.

The request analysis module 112 can, at times, determine artificial intelligence sub-intent through behavioral inference rather than relying solely on requestor self-identification or declared purpose. Behavioral inference operates by evaluating a plurality of observable request signals that, individually or in combination, indicate the downstream computational objective of the requestor. Such signals include, without limitation, request cadence, request-path traversal patterns, asset-fetch selectivity, header composition anomalies, JavaScript execution absence, cookie or session state handling, content-negotiation preferences, authentication posture, and transport-layer characteristics. The request analysis module 112 may compare observed behavioral signals against a trained classification model or a maintained catalog of known agent frameworks, headless browser signatures, retrieval pipeline clients, and API consumers to generate a confidence-scored sub-intent profile. Where a single behavioral signal is inconclusive, the module may aggregate signals across multiple dimensions to resolve a weighted intent label or to select a confidence-gated fallback representation.

Different artificial intelligence sub-intents produce characteristic behavioral fingerprints that the request analysis module 112 is configured to recognize. A training ingestion requestor typically exhibits broad, high-volume crawl patterns with full-page access distributed across a large number of uniform resource locators, minimal repeat visits, and indifference to navigational scripts, stylesheets, or session state. A real-time inferencing requestor typically exhibits low request volume directed at specific content endpoints, short inter-request intervals consistent with just-in-time retrieval, and origin addresses associated with known inference infrastructure. A retrieval refresh requestor typically issues conditional HTTP requests carrying validators such as ETags or If-Modified-Since headers, revisits previously accessed uniform resource locators at periodic intervals, and requests semantically coherent page segments rather than full-page payloads. An entity extraction requestor typically traverses structured-data-rich pages, preferentially accesses JSON-LD, schema. org, or other semantic markup endpoints, and exhibits graph-like link-traversal patterns consistent with knowledge-base population. An artificial intelligence agent browser engaged in functional execution typically exhibits session-like behavior including form interactions, state transitions, token or cookie management, and multi-step navigation sequences that differ materially from both human browsing patterns and bulk extraction loops. By recognizing these distinguishing behavioral profiles, the request analysis module 112 can resolve a sub-intent classification without requiring the requestor to declare its purpose, thereby improving classification accuracy for requestors that present misleading or generic user-agent identifiers.

### Edge Deployment and Macro-Intent Telemetry

In some embodiments, the request analysis module 112 is deployed at an edge network layer comprising a content delivery network, a web application firewall, or a shared cloud hosting layer. In such deployments, the request analysis module 112 may aggregate telemetry across multiple distinct domains hosted on the same network fabric. Aggregated telemetry can include transport-layer fingerprinting, internet protocol address behavior, autonomous system number behavior, subnet hopping behavior, cross-domain transition timing, aggregate request volume, repeated task patterns, and other macro-behavioral signals.

Cross-domain telemetry permits the system to determine a macro-intent that supersedes a localized interaction pattern observed at a single page or domain. For example, a requestor may appear human-like on one site while simultaneously executing repeated extraction loops across multiple unrelated domains. The system may update a global reputation profile for that requestor and preemptively route subsequent requests on another hosted domain to a machine-oriented representation path, thereby reducing infrastructure strain and improving early classification accuracy.

In another embodiment, the request analysis module 112 is configured to perform source disambiguation when multiple distinct artificial intelligence requestors operate from a common network origin, such as a shared Internet Protocol (IP) address, a Network Address Translation (NAT) gateway, or a cloud egress proxy. Rather than assigning a single, monolithic macro-intent to the common network origin, the request analysis module evaluates multiplexed traffic streams to identify connection-level micro-signatures. These micro-signatures may include variations in Transport Layer Security (TLS) handshakes, HTTP/2 or HTTP/3 stream concurrency patterns, ephemeral port cycling, header capitalization anomalies, and session-state rotation. By isolating these micro-signatures, the system demultiplexes the aggregated traffic to identify the behavioral footprints of multiple independent agents.

For example, the system may classify a first request stream from a shared IP address as a training ingestion sub-intent, while simultaneously classifying a concurrent second request stream from the identical IP address as a real-time inferencing sub-intent. The representation selector then dynamically serves a semantic corpus representation to the first stream and a compact fact-chunk payload to the second stream, seamlessly satisfying multiple distinct machine objectives originating from the same network source, on a per session basis.

### Selecting Machine-Oriented Representations

The machine-oriented representations available to the selector 114 may include, without limitation, a token-reduced semantic representation, a compact fact-chunk representation, a schema-structured representation, a transcript-based semantic representation, a metadata-only representation, or an actionable form-schema or API-like representation. Different representations may be cached separately, subject to distinct access control rules, or associated with distinct integrity metadata. In some embodiments, the system dynamically generates the selected representation on-the-fly at request time.

In further embodiments, the system is configured to store pre-generated representations. By way of example, a web page authoring application, such as Wix, may comprise a real-time intelligent suggestion engine configured to guide a user during the modification of a pre-generated web page. The suggestion engine may facilitate the balancing of the web page by selectively compromising predetermined aesthetic features in favor of artificial intelligence optimization. Furthermore, the suggestion engine may automatically generate secondary web pages optimized for LLMs concurrently with the manual generation of the primary, presentation-optimized web page. In one embodiment, the system provides a graphical user interface (GUI) control element, such as a slider, enabling the user to dynamically balance suggestions or the automatic generation of the web page among presentation parameters, SEO for indexing, and artificial intelligence optimization. Additionally, a predetermined token budget may be input as a configuration parameter during web page creation, and a specific LLM (e.g., Llama or Claude) may be designated to execute model-specific, fine-tuned optimization.

A content transformation engine 116 may be used to generate one or more machine-oriented representations. The content transformation engine may remove presentation markup, styling code, navigational elements, and non-substantive interface content; linearize or flatten structural hierarchy; preserve or normalize headings; convert visual tables into text-centric or delimited structures; inject provenance markers or citation anchors; and associate extracted entities, attributes, relationships, or timelines with structured fields. The transformation engine 116 may operate when a web resource is published or updated, on a scheduled basis, or dynamically in response to a classified request.

### Sub-Intent: Training Ingestion

When the classified artificial intelligence sub-intent comprises training ingestion or corpus acquisition, the selected machine-oriented representation may comprise a semantic corpus representation generated by removing presentation markup, styling code, navigational elements, advertising modules, and non-substantive interface content from the web resource. The content transformation engine 116 may preserve headings, tables, and citation structure while linearizing nested page structure into ordered semantic sections.

In such embodiments, the resulting output may be encoded as normalized Markdown, JSON, JSON-LD, RDF, XML, delimited text, or another machine-consumable format suitable for large-scale ingestion, pretraining, or fine-tuning. The delivery path prioritizes semantic cleanliness, broad informational coverage, and reduction of rendering-oriented noise.

### Sub-Intent: Real-Time Inferencing

When the classified artificial intelligence sub-intent comprises real-time inferencing or on-demand retrieval, the selected machine-oriented representation may comprise a compact fact-chunk payload or a metadata-optimized response configured for just-in-time citation. This payload may emphasize high-salience factual assertions, short supporting spans, canonical identifiers, evidence anchors, and confidence metadata while omitting long-form transitions, decorative interface material, and other low-value text regions.

This delivery variation prioritizes low latency, token compactness, and reduced context-window consumption relative to a broader corpus-oriented representation or a default presentation-layer representation.

### Sub-Intent: Retrieval Refresh

When the classified artificial intelligence sub-intent comprises retrieval refresh, indexing, or corpus maintenance, the selected machine-oriented representation may comprise modular vector-ready segments corresponding to semantically coherent portions of the web resource. The system may preserve retrieval-relevant headers and section labels, attach provenance metadata, and maintain stable chunk boundaries across content revisions so that only modified segments need to be refreshed downstream.

This variation is especially useful for retrieval-augmented generation pipelines, vector database maintenance, and other systems that benefit from semantically partitioned and update-friendly representations rather than full-page rendering.

### Sub-Intent: Entity Extraction

When the classified artificial intelligence sub-intent comprises entity extraction, attribute extraction, or knowledge-graph population, the selected machine-oriented representation may comprise a schema-rich structured payload including entities, attributes, or relationships extracted from the web resource. The transformation engine may normalize aliases, attach stable identifiers, map entities to ontology terms, associate properties with source citations, and emit typed predicates or event structures for downstream parsing.

In such embodiments, the objective is not merely reduced token count, but preservation of relational fidelity, provenance, and schema alignment for downstream systems that consume structured knowledge rather than free-form prose.

### Sub-Intent: Media Understanding

When the classified artificial intelligence sub-intent comprises media understanding, the selected machine-oriented representation may comprise a transcript, caption data, temporal segmentation, asset metadata, or combinations thereof corresponding to media included in the web resource. For video resources, the system may provide verified transcripts, chapter boundaries, descriptive scene summaries, prompt metadata for AI-generated scenes, and structured metadata such as schema objects describing content, entities, and timeline segments. For audio resources, the representation may include speaker-separated transcripts, topic segmentation, timestamps, and extracted factual claims. For image-heavy resources, the representation may include normalized alternate text, object descriptors, caption associations, or text extracted from embedded image regions.

By delivering synchronized semantic information in place of or in addition to the presentation-layer media asset, the system can reduce multimodal processing burden that would otherwise arise from frame-by-frame or signal-level analysis.

### Sub-Intent: Quality or Compliance Evaluation

When the classified artificial intelligence sub-intent comprises quality, safety, trust, or compliance evaluation, the selected machine-oriented representation may emphasize provenance, citation traceability, authorship, timestamps, rule-specific metadata, moderation labels, verification status, jurisdictional classifications, or integrity metadata. In such embodiments, the representation may preserve fact-evidence pairs or claim lineage even when the representation is more compact than the default presentation-layer representation.

This delivery path is particularly useful when the consuming system evaluates not just what a page states, but whether the information can be verified, governed, or scored against a policy regime.

### Sub-Intent: Functional Execution by an AI Agent Browser

When the classified artificial intelligence sub-intent comprises functional execution by an artificial intelligence agent browser, the request analysis module may further resolve whether the requestor seeks full interactive fidelity, data extraction, content understanding, state-transition completion, or workflow execution. If full interactive fidelity is required, the server may transmit the default presentation-layer representation comprising rendered HTML and associated scripts or assets. In certain embodiments, that transmission may be accompanied by policy controls such as rate limiting, sandboxing, authentication gating, or challenge-response verification.

If the resolved objective is functional execution or navigation completion rather than full visual fidelity, the selected machine-oriented representation may comprise an actionable form schema, a structured semantic payload, an entity-attribute map, a workflow manifest, a state-transition graph, or a dedicated API-like metadata response. By providing a machine-readable interaction pathway, the system can reduce brittle user-interface automation and lower downstream computational overhead.

### Additional Emerging Sub-Intents

The system may further classify emerging artificial intelligence sub-intents. Examples include tool-selection or function-routing, in which a requesting model seeks action capabilities, input schemas, output schemas, authentication rules, or rate-limit constraints; workflow planning, in which an agent seeks preconditions, dependencies, branching logic, and terminal states for a larger objective; long-horizon memory consolidation, in which a requestor seeks durable facts, stable identifiers, and de-duplicated assertions for persistent memory storage; and session continuation or state resumption, in which an autonomous agent seeks current workflow position, pending fields, checkpoint metadata, or resumable interaction tokens.

Additional emerging sub-intents may include multi-agent coordination, self-verification or adversarial checking, personalization-context extraction, commerce-decision support, environment or sensor grounding, and robotic or embodied execution support. In each case, the selected representation may vary according to the inferred downstream purpose rather than merely according to client identity.

### Verification and Integrity Metadata

In some embodiments, the selected machine-oriented representation includes integrity metadata or a verification hash associating the machine-oriented representation with the default presentation-layer representation. The verification hash may be generated from the default representation, from a canonical fact graph derived from multiple representations, or from another normalized content baseline. Integrity metadata may be used to confirm factual consistency among representations, facilitate auditing, and reduce risk that differing delivery paths are interpreted as materially inconsistent content. In some cases, third-party ingestors refrain from penalizing web resources in their rankings algorithm, when accompanied by a verification hash.

In some implementations, integrity verification may be performed by a third-party or separate service to provide additional assurance of consistency between representations.

### Balancing Control

Certain deployment environments may constrain the number of page variants that can be stored or served. In such embodiments, an administrative balancing control may be used to weight preferences among a default presentation-layer representation, a general machine-readable representation, and a more specialized sub-intent-specific representation. The balancing control may be implemented as a slider, rules engine, or policy table. Administrative preferences may bias delivery toward conventional web-search objectives, toward generalized machine extractability, or toward aggressive sub-intent optimization while still preserving minimum consistency constraints among representations.

In another embodiment, a single web page composition (or composition for a group of web pages) is balanced between human and non-human presentation. In yet another embodiment, the single web page is balanced between human presentation, web indexer SEOs and artificial intelligence ingestion. In still another embodiment, the single web page is balanced between different artificial intelligence sub-intents.

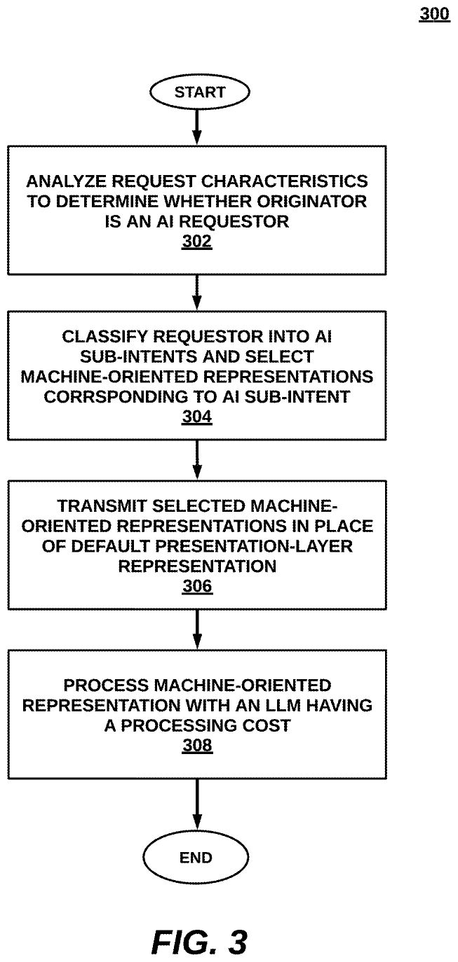

### II. Methods for Intent-Optimized Web Content Delivery for AI Ingestion (FIG. 3)

An example method begins by receiving, at a server system, a request for a web resource from a client device. The system analyzes one or more request characteristics to determine whether the request originates from an artificial intelligence requestor (302). Responsive to determining artificial intelligence origin, the system classifies the requestor into one of a plurality of artificial intelligence sub-intents and selects, based on the classified sub-intent, one of a plurality of machine-oriented representations of the web resource (304). The system then transmits the selected machine-oriented representation in place of a default presentation-layer representation (306). Upon receipt, the machine-oriented representation can be processed by an LLM having a processing cost. LLM usage may also incur a direct monetary cost, for example where a model provider charges based on input tokens, output tokens, requests, context length, compute tier, or multimodal processing. Accordingly, reducing unnecessary tokens and non-substantive content can reduce not only inference overhead and latency, but also out-of-pocket usage expense.

In some embodiments, the selected representation is configured to reduce at least one of token count, markup complexity, bandwidth consumption, latency, or multimodal processing burden relative to the default presentation-layer representation. In some embodiments, a confidence score associated with the classified sub-intent determines whether a specialized representation, a fallback representation, or a blended representation is delivered.

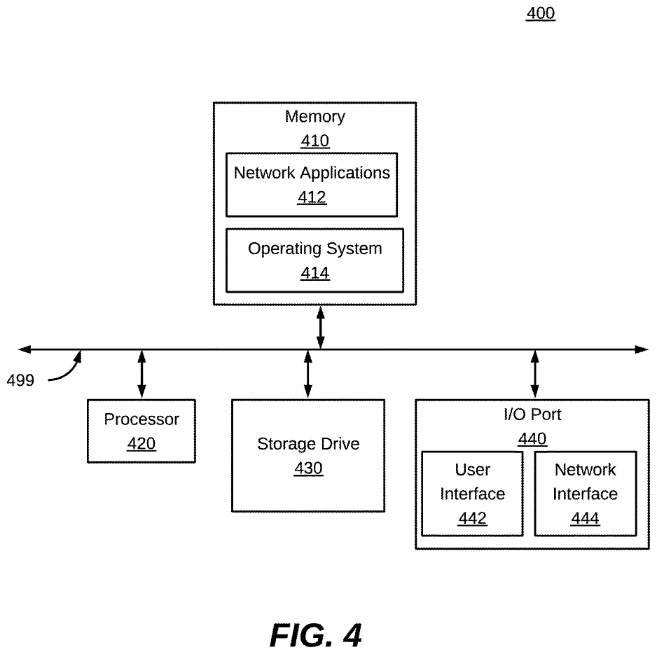

### III. Computing Environment for Intent-Optimized Web Content Delivery for AI Ingestion (FIG. 4)

A computing device 400 suitable for implementing the web host, edge server, request analysis module, representation selector, content transformation engine, telemetry aggregation engine, or verification module may include one or more processors, memory, persistent storage, and input-output interfaces connected by one or more buses. The computing device 300 may communicate through wired or wireless interfaces using Ethernet, Wi-Fi, optical links, cellular links, or other network connections. Program instructions stored in non-transitory computer-readable media may cause the device to perform the methods described herein.

In the computing device 400, a memory 410 stores network applications 412, such as web host application, running on an operating system 414. A bus 499 connects the memory 410 to a processor 410, a long-term storage drive 430, and an I/O port 440 with a user interface 442 and a network interface 444. Different physical devices can have different variations of computing architecture.

The techniques described herein may be implemented in software, hardware, firmware, or any combination thereof. The software may be written in any suitable programming language and may execute at an origin server, reverse proxy, cloud edge service, gateway, or distributed system of cooperating nodes.

Computer software products (e.g., non-transitory computer products storing source code) may be written in any of various suitable programming languages, such as C, C++, C #, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems). Some embodiments can be implemented with artificial intelligence.

Furthermore, the computer device 400 that is running the previously mentioned computer software may be connected to a network and may interface with other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

### IV. Generalities of Description

This description of the invention has been presented for the purposes of illustration and description. It is not intended to be exhaustive or to limit the invention to the precise form described, and one of ordinary skill in the art will recognize many modifications and variations are possible in light of the teaching above. The embodiments were chosen and described in order to best explain the principles of the invention and its practical applications, in a concise manner. This description will enable others skilled in the art to best utilize and practice the invention in various embodiments and with various modifications as are suited to a particular use.

The scope of the invention is defined by the following claims.

I claim:

1. A computer-implemented method in a server system, implemented at least partially in hardware, for delivering a web resource that reduces Large Language Model (LLM) processing cost, the method comprising:
receiving, from a network interface card communicatively coupled to a data communication network, a request for the web resource from a client device;
analyzing, by a processor, one or more request characteristics to determine that the request originates from an artificial intelligence requestor;
classifying, by the processor, the artificial intelligence requestor into one of a plurality of artificial intelligence sub-intents comprising at least one of:
training ingestion, real-time inferencing, retrieval refresh, entity extraction, media understanding, quality or compliance evaluation, and functional execution by an artificial intelligence agent browser;
selecting, by the processor, based on the classified artificial intelligence sub-intent, one of a plurality of machine-oriented representations of the web resource; and
sending, to the network interface card for transmission by the network interface card, the selected machine-oriented representation in place of a default presentation-layer representation of the web resource, wherein the selected machine-oriented representation is configured to reduce LLM processing cost with a lower token count relative to the default presentation-layer representation.

2. The method of claim 1, wherein the one or more request characteristics comprise one or more of header analysis, client-hint analysis, user-agent fingerprinting, content-negotiation headers, request path patterns, authentication or session state, request cadence, anomaly scoring, policy rules, or machine-learned classification.

3. The method of claim 1, wherein the plurality of machine-oriented representations comprises at least two of:
a token-reduced semantic representation, a compact fact-chunk representation, a schema-structured representation, a transcript-based semantic representation, a metadata-only representation, or an actionable form-schema or API-like representation.

4. The method of claim 1, wherein the classified artificial intelligence sub-intent comprises training ingestion, and wherein the selected machine-oriented representation comprises a semantic corpus representation generated by removing presentation markup, styling code, navigational elements, and non-substantive interface content from the web resource.

5. The method of claim 1, wherein the classified artificial intelligence sub-intent comprises real-time inferencing, and wherein the selected machine-oriented representation comprises a compact fact-chunk payload or a metadata-optimized response configured for just-in-time citation.

6. The method of claim 1, wherein the classified artificial intelligence sub-intent comprises retrieval refresh, and wherein the selected machine-oriented representation comprises modular vector-ready segments corresponding to semantically coherent portions of the web resource.

7. The method of claim 1, wherein the classified artificial intelligence sub-intent comprises entity extraction, and wherein the selected machine-oriented representation comprises a schema-rich structured payload including entities, attributes, or relationships extracted from the web resource.

8. The method of claim 1, wherein the classified artificial intelligence sub-intent comprises functional execution by an artificial intelligence agent browser, and wherein the selected machine-oriented representation comprises an actionable form schema, a structured semantic payload, an entity-attribute map, or a dedicated API-like metadata response.

9. The method of claim 8, wherein, responsive to determining that full interactive fidelity is required by the artificial intelligence agent browser, the server system transmits the default presentation-layer representation comprising rendered Hypertext Markup Language (HTML) and associated scripts or assets.

10. The method of claim 1, wherein the classified artificial intelligence sub-intent comprises media understanding, and wherein the selected machine-oriented representation comprises a transcript, caption data, temporal segmentation, asset metadata, or combinations thereof corresponding to media included in the web resource.

11. The method of claim 1, wherein the selected machine-oriented representation includes integrity metadata or a verification hash associating the selected machine-oriented representation with the default presentation-layer representation.

12. The method of claim 1, wherein the requestor act on behalf of an internal audit process of web resources.

13. The method of claim 1, wherein a web host stores a plurality of default presentation layer web resources accessed by the server system.

14. The method of claim 1, wherein an LLM processes the machine-oriented representation of the web resource, and wherein the LLM extols an LLM processing cost based on one or more of input tokens, output tokens, requests, context length, compute tier, and multimodal processing.

15. The method of claim 1, wherein the default presentation-layer representation comprises a human-facing browser representation of the web resource.

16. The method of claim 15, wherein the human-facing browser representation comprises an HTML representation.

17. The method of claim 1, further comprising classifying a non-artificial-intelligence automated requestor as an index crawler and, in response, transmitting an HTML representation of the web resource.

18. The method of claim 1, wherein selecting the machine-oriented representation comprises detecting an llms.txt file associated with the requested web resource and serving, responsive to classification of the request as an artificial-intelligence request, content derived from the llms.txt file instead of or in preference to a default presentation-layer representation.

19. A non-transitory computer-readable media, storing instructions that, when executed by a processor, performs a method in a server system, implemented at least partially in hardware, for delivering a web resource that reduces Large Language Model (LLM) processing cost, the method comprising:
receiving, from a network interface card communicatively coupled to a data communication network, a request for the web resource from a client device;
analyzing one or more request characteristics to determine that the request originates from an artificial intelligence requestor;
classifying, by the processor, the artificial intelligence requestor into one of a plurality of artificial intelligence sub-intents comprising at least one of:
training ingestion, real-time inferencing, retrieval refresh, entity extraction, media understanding, quality or compliance evaluation, and functional execution by an artificial intelligence agent browser;
selecting, by the processor, based on the classified artificial intelligence sub-intent, one of a plurality of machine-oriented representations of the web resource; and
sending, to the network interface card for transmission by the network interface card, the selected machine-oriented representation in place of a default presentation-layer representation of the web resource, wherein the selected machine-oriented representation is configured to reduce LLM processing cost with a lower token count relative to the default presentation-layer representation.

20. A system for serving sub-intent-specific representations of a web resource, the system comprising:
a request analysis module configured to determine, from request characteristics, that a request originates from an artificial intelligence requestor and to classify the artificial intelligence requestor into a sub-intent;
a representation selector configured to map the sub-intent to one of a plurality of machine-oriented representations of the web resource; and
a server configured to retrieve or generate the mapped machine-oriented representation and transmit the mapped machine-oriented representation instead of a default presentation-layer representation of the web resource.
